(19) United States
(12) Patent Application Publication
(10) Pub. No.: US 2025/0083418 A1
(43) Pub. Date: Mar. 13, 2025

(54) LAMINATED GLAZING HAVING A FUNCTIONAL FILM

(71) Applicant: SAINT-GOBAIN GLASS FRANCE, COURBEVOIE (FR)

(72) Inventors: Laurent MAILLAUD, MASSY (FR); Michael LABROT, AACHEN (DE)

(73) Assignee: SAINT-GOBAIN GLASS FRANCE, COURBEVOIE (FR)

(21) Appl. No.: 18/580,520

(22) PCT Filed: Jul. 18, 2022
(86) PCT No.: PCT/FR2022/051423

§ 371 Date: Jan. 18, 2024

(30) Foreign Application Priority Data
Jul. 19, 2021 (FR) 2107778

(51) Int. Cl. B32B 17/10; B32B 1/00

(52) U.S. Cl. CPC B32B 17/10504; B32B 1/00; B32B 17/10036; B32B 17/10449; B32B 17/10798; B32B 2307/536; B32B 2605/00

(57) ABSTRACT

Provided is a laminated glazed unit having at least one first glass substrate and a second glass substrate, at least one functional film arranged between the two glass substrates, at least one first lamination interlayer film between the first glass substrate and the functional film, and at least one second lamination interlayer film between the second glass substrate and the functional film. The functional film has at least one layer of a transparent adhesive material, referred to as OCA, which is viscoelastic so as to be deformable in its thickness during the process for laminating the glazed unit.

The invention relates to the field of laminated glazed units.

The invention will be applicable for all uses, especially for construction, such as exterior walls or partitions or other interior glazed surfaces, or for vehicles of the car, bus, train or aircraft type.

A laminated glazed unit comprises two external glass substrates and at least one interlayer film made of plastic material commonly of polyvinyl butyral (PVB), securely attaching the two glass substrates to one another. A laminated glazed unit may further comprise one or more other films, referred to as functional films, for example infrared-reflecting films or liquid crystal films. A laminated glazed unit which incorporates a sandwiched functional film comprises, between the two external glass substrates, the functional film such as a liquid crystal cell which is securely attached to the glass substrates by a PVB film coupled to each of the faces of the cell.

A liquid crystal cell is in the form of a flexible film comprising liquid crystals encapsulated between two encapsulation sheets made of polymer material which are kept a constant distance apart by virtue of spacers such as glass beads. Each polymer encapsulation sheet is provided with an electrode. When a voltage is applied to the electrodes, the liquid crystals change orientation and modify the light transmission through the cell, with the glazed unit provided with the liquid crystal cell going from a light state to a dark state, or vice-versa. “Light state, dark state” is intended to mean that the glazed unit has in the light state thereof a light transmission in the visible range which is greater than the light transmission it has in the dark state thereof.

The liquid crystal cells are in particular used in certain construction applications with flat glass. This technology has also recently become of interest in the automotive field where glazed units require darkening of the glass, such as for sunroofs, rear windows, side windows or the shaded strips in the upper part of a windshield. However, in the automotive field, the glazed units are bent and the lamination of functional films other than PVB films proves not to be particularly simple. The flexibility of the (liquid crystal or otherwise) functional films which are flexible should in theory make it possible for them to follow a curved shape relatively easily. However, it has been observed that, in reality, bending causes significant visual defects. Indeed, a bent glazed unit is curved in two directions. While the functional film is flexible, it has to deform locally in two directions to follow the curved shape, which is ultimately difficult to achieve. This gives rise to significant visual defects, such as creasing of the film in certain locations, in particular mainly at the edges of the glazed unit. These defects are unacceptable from an aesthetic perspective.

Moreover, the process for manufacturing a laminated glazed unit, especially implemented using a vacuum bag and an autoclave, involves high pressures and temperatures. In the case of liquid crystal functional films, these stresses may lead to local deformations in the polymer encapsulation sheets of the liquid crystal cell, in particular an increase in the thickness of the cell. These deformations cause local modification of the orientation of the liquid crystals, which is further accentuated when the glazed unit is bent. This results in inhomogeneous light transmission for the glazed unit, further reflected visibly in the presence of dark zones on a glazed unit which is normally light, or conversely the presence of light zones on a glazed unit which is normally dark.

The aim of the invention is therefore to propose a laminated glazed unit comprising at least one flexible functional film which is laminated containing lamination interlayers, the laminated glazed unit not having the abovementioned disadvantages such as optical defects such as creases or the presence of inhomogeneous light transmission zones when the flexible functional film contains liquid crystals.

According to the invention, the laminated glazed unit comprises at least one first glass substrate and a second glass substrate, at least one functional film arranged between the two glass substrates, and also at least one first lamination interlayer film between the first glass substrate and the functional film, and at least one second lamination interlayer film between the second glass substrate and the functional film (the functional film being flexible when it is handled during the manufacturing process for laminating the glazed unit). Moreover, the functional film comprises at least one layer of a transparent adhesive material (referred to as OCA-Optically Clear Adhesive), which is viscoelastic so as to be deformable in its thickness during the process for laminating the glazed unit.

The OCA, integrated in this way into the flexible functional film, is not solid. The OCA has a viscoelasticity such that it is able to locally vary in thickness when the functional film is subjected to deformation stresses during the process for laminating the glazed unit.

“Functional film” is intended to mean a film which confers at least one technical function upon the glazed unit, such as a solar control film (for example infrared-absorbing and/or reflecting), a film for protecting against ultraviolet radiation. It may also be an active film, such as a film which makes it possible to control the opacity and/or light transmission, or else a heating film, etc.

The term “transparent”, for the OCA, is intended to mean a material which has a light transmission of greater than or equal to 80%, preferably at least 90%. The light transmission is calculated according to ISO standard 9050:2003. In the event of measuring the light transmission of an OCA, the measurement will be carried out on a 1 mm-thick sample.

The OCA is in liquid form before manufacture of the functional film, and is able to crosslink after the application thereof to at least one (flexible) substrate which constitutes the support for the OCA and may have the or a technical function of the functional film. Another flexible substrate having a technical function may be associated therewith. The way in which the liquid OCA crosslinks depends on its nature. The OCA may be crosslinked especially by providing energy of the ultraviolet type, or at ambient temperature with the addition of a curing agent.

This technical characteristic of integrating a viscoelastic OCA to the functional film has unexpectedly proven particularly advantageous for manufacturing a bent laminated glazed unit. Surprisingly, the presence of a viscoelastic OCA in the functional film makes it possible to greatly reduce the visible defects on the glazed unit after manufacture, such as creases.

Said at least one functional film integrated into the glazed unit is an independent film and can be handled as is before the manufacture of the glazed unit. It is a ready-to-use film which is stacked with all the glass substrates and lamination films in the customary manner during the manufacture of a laminated glazed unit. The functional film is used like any type of PVB-type film in the usual manufacture of a laminated glazed unit, in particular in the manufacture of a bent laminated glazed unit.

According to one characteristic, said at least one viscoelastic OCA layer has a hardness of between 10 and 50 Shore000, especially between 10 and 30 Shore000. The hardness is measured according to standard ASTM-D2240 on a 10 mm-thick sample, the sample consisting of the (UVA-) crosslinked OCA after having been poured in liquid form into a hollow mold.

According to another characteristic, said at least one viscoelastic OCA layer has an elongation at break of between 200% and 1000%, especially between 250% and 1000%, preferably between 300% and 1000%.

According to another characteristic, the functional film comprises at least: a first flexible transparent substrate, a first OCA layer and a second flexible transparent substrate, the first flexible transparent substrate and/or the second flexible transparent substrate having a technical function in order to provide said functional film with the technical function. The outermost flexible transparent substrates of the functional film are composed of a material different from PVB (polyvinyl butyral) or EVA (ethylene-vinyl acetate).

According to one embodiment, the functional film comprises a first flexible transparent substrate, a first OCA layer, a second flexible transparent substrate having a technical function, a second OCA layer and a third flexible transparent substrate. The first and/or the third flexible transparent substrate may have a technical function which will be different from that of the second flexible transparent substrate.

By way of nonlimiting examples of technical function, a flexible transparent substrate of the functional film may be a solar control film (for example infrared-reflecting and/or absorbing), a UV protection film, a film enabling the opacity to be varied, or else a film enabling the light transmission to be varied. Thus, according to one characteristic, the functional film comprises a flexible transparent substrate having a technical function which is an infrared-reflecting film.

The flexible transparent substrate having a technical function of the functional film is for example a PET (polyethylene terephthalate), PC (polycarbonate), PI (polyimide), PU (polyurethane) or TAC (cellulose triacetate) film.

In another exemplary embodiment, the or one of the flexible transparent substrates having a technical function of the function film is a liquid crystal cell. The liquid crystal cell forms a flexible film which is inherently handleable. The liquid crystal cell is intended to provide the glazed unit with a function for varying its light transmission.

The inventors have demonstrated that, to manufacture a glazed unit which has to comprise a liquid crystal cell, laminating a liquid crystal cell in the form of a flexible film comprising a liquid crystal cell and at least one OCA layer which is viscoelastic so as to be deformable in its thickness during the process for laminating the glazed unit minimizes the risk of visual defects in the glazed unit such as creases or defects of inhomogeneous light transmission. Furthermore, the presence of such a viscoelastic OCA has the advantage of very greatly reducing the risk of crack propagation at the electrodes of the liquid crystal cell during the use of the glazed unit which undergoes cycles of deformation due to the cycles of temperature variation.

The liquid crystal cell may be in the form of a so-called “guest-host” cell containing a mixture of a liquid solution and liquid crystals. The liquid solution containing liquid crystals is trapped in a cavity delimited by two encapsulation substrates and a peripheral seal. The two encapsulation substrates are made of flexible polymer material. The liquid solution containing the liquid crystals may comprise one or more dichroic dyes. The liquid crystal cell comprising a mixture of a liquid solution and liquid crystals, wherein one or more dichroic dyes are dispersed, is generally referred to as a “guest-host” liquid crystal cell.

The guest-host liquid crystal cell may further comprise polarizers (on one or the external faces of the cell).

As a variant of a guest-host liquid crystal cell, the liquid crystal cell may be a polymer-dispersed liquid crystal (PDLC) system or a cholesteric liquid crystal (CLC) system or else a polymer network liquid crystal (PNLC) system. These cells are in the form of a flexible substrate.

According to yet another characteristic, the OCA selected according to the invention is selected from OCAs based on acrylic, on polyvinyl acetate, on polyurethane, on silicon, and on epoxy.

The laminated glazed unit according to the invention may be a construction glazed unit. It may be used in a double glazed unit or in a triple glazed unit.

The laminated glazed unit of the invention may be a vehicle glazed unit, especially for a vehicle selected from a car, a train, a truck, an aircraft, a bus, and a military vehicle.

Advantageously, the laminated glazed unit may be bent.

The invention also relates to a use of a functional film in the manufacture of a laminated glazed unit, the functional film being sandwiched between two lamination interlayers and two glass substrates, characterized in that the (flexible) functional film comprises at least one layer of a transparent adhesive material (OCA) which is viscoelastic so as to be deformable in its thickness during the process for laminating the glazed unit, the OCA in particular having a hardness of between 10 and 50 Shore000.

Other characteristics and other advantages of the invention will become apparent on reading the following description, given solely by way of nonlimiting example and made with reference to the appended drawings, in which

The present invention is now described by means of examples that are solely illustrative and in no way limiting with respect to the scope of the invention, and on the basis of the attached illustrations, in which:

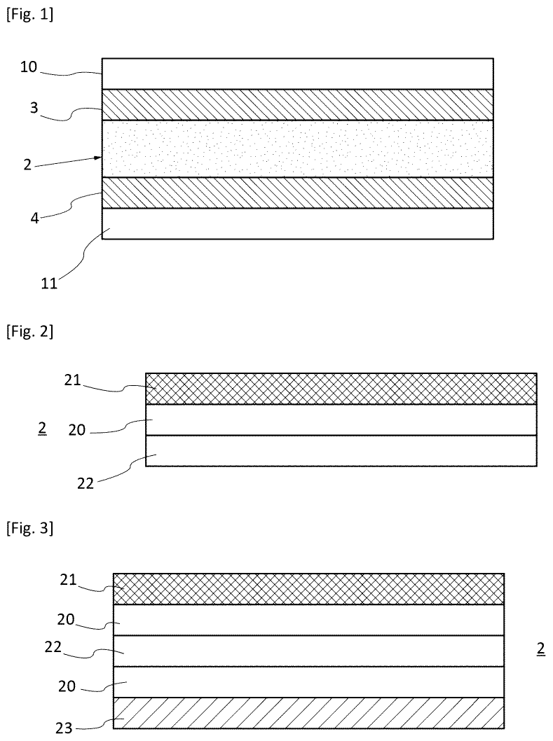

FIG. 1 represents a schematic partial lateral sectional view of a laminated glazed unit according to the invention.

FIG. 2 is a schematic sectional view of an embodiment of a functional film according to the invention intended to be integrated into the glazed unit of FIG. 1, the functional film comprising a single OCA layer.

FIG. 3 is a schematic sectional view of another embodiment of a functional film according to the invention comprising two OCA layers arranged on either side of a flexible substrate having a technical function.

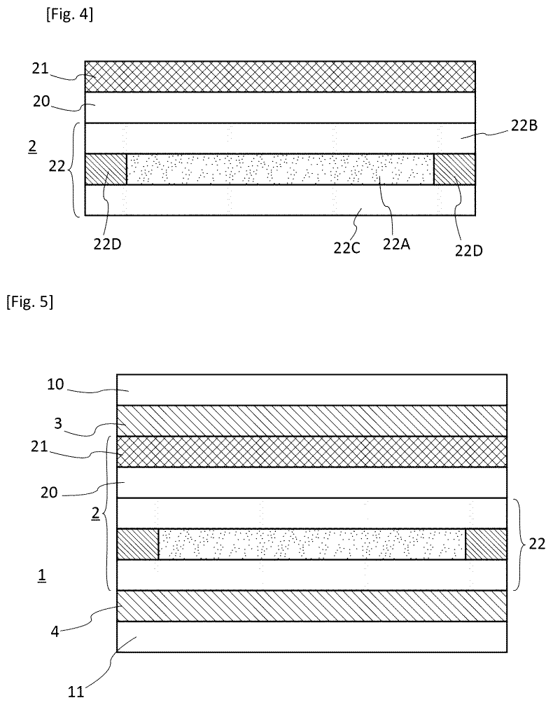

FIG. 4 corresponds to FIG. 2, integrating a liquid crystal cell into the functional film.

FIG. 5 shows a laminated glazed unit integrating the functional film of FIG. 4.

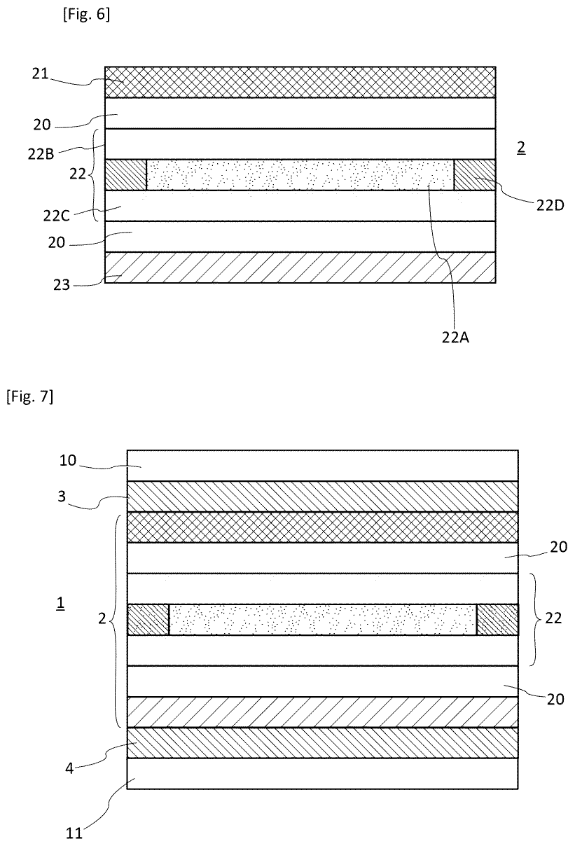

FIG. 6 corresponds to the exemplary embodiment of the functional film of FIG. 3, integrating a liquid crystal cell.

FIG. 7 shows an exemplary embodiment of laminated glazed unit integrating the functional film of FIG. 6.

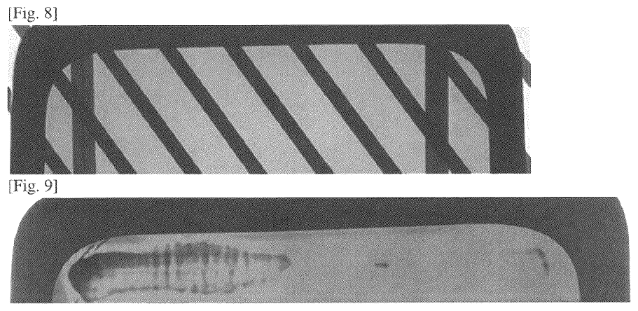

FIG. 8 is a partial photo of a laminated glazed unit of the invention in accordance with FIG. 5.

FIG. 9 is a partial photo of a comparative laminated glazed unit comprising a functional film having a guest-host cell without OCA.

For the sake of clarity, the various elements represented in the figure are not necessarily reproduced to scale.

The laminated glazed unit 1 of the invention shown in FIGS. 1 and 2 has at least one technical function which cannot be integrated into a customary lamination film of PVB or EVA type. Said at least one technical function is integrated into a functional film 2 shown in FIGS. 2 and 3, which is multilayered and comprises, according to the invention, at least one OCA layer 20, the OCA being furthermore viscoelastic so as to be deformable in its thickness during the process for laminating the glazed unit.

The laminated glazed unit 1 may especially be bent while minimizing, by virtue of the functional film 2, optical defects such as creases at the edge of the glazed unit.

Of course, the lamination films 3 and 4 and/or the glass substrates 10 and 11 may also have technical functionalities such as blocking ultraviolet rays, infrared protection, and acoustic, antireflective, non-stick, scratch-resistant, photocatalytic, fingerprint-resistance, anti-fogging or coloring properties.

The technical function presented by way of nonlimiting example for the functional films 2 of FIGS. 4 and 6, and for the glazed units of the respective FIGS. 5 and 7 integrating respectively the functional films of FIGS. 4 and 6, is a liquid crystal-variable light transmission function. This technical function is especially used for car glazed units.

As shown in FIG. 1, the laminated glazed unit 1 has at least one first glass substrate 10 and a second glass substrate 11, respectively constituting the exterior substrates of the glazed unit, at least one functional film 2, and a first lamination interlayer film 3 which securely attaches the first glass substrate 10 of the functional film 2, and a second lamination interlayer film 4 which securely attaches the second glass substrate 11 of the functional film 2.

The glass substrates 10 and 11 have a thickness which is suitable for the use of the laminated glazed unit. The thickness may be between 0.3 mm and 15 mm, preferably between 1 and 5 mm; for example, it is 1.6 mm, 1.8 mm or 2.1 mm.

The lamination interlayer films 3 and 4 especially have a thickness of between 0.07 mm and 2 mm, in particular of 0.38 mm or 0.76 mm.

The first and second lamination interlayer films 3 and 4 are for example made of PVB.

The functional film 2 is a flexible film which can be independently handled and deposited on one of the lamination interlayer films 3 or 4 during the stacking of the various substrates and films for the manufacture of the glazed unit by the lamination process.

With regard to FIG. 2, the functional film 2 comprises at least one first OCA layer 20 sandwiched between a first flexible transparent substrate 21 and a second flexible transparent substrate 22, the first flexible transparent substrate and/or the second flexible transparent substrate having a technical function. The OCA is trapped in the functional film 2.

The technical function is for example given to the second flexible substrate 22 which consists for example of an infrared-reflecting PET film or, as shown in FIGS. 4 to 7, is a liquid crystal cell for varying the light transmission of the laminated glazed unit 1.

As shown in FIG. 3, the functional film 2 may have a third flexible substrate 23 which is applied to the second flexible substrate 22 while arranging, as an interface, another OCA layer 20. The second and third flexible substrates 22 and 23 for example each have a technical function.

The OCA layer 20 of the flexible functional film 2 is made of a transparent viscoelastic material such that, during the process for laminating the glazed unit, the OCA layer 20 (trapped in the functional film) is locally deformable in its thickness in the functional film during the lamination of the glass substrates 10 and 11 of said functional film 2. As a result, the OCA layer 20 is sufficiently elastic to deform during the autoclaving step and to absorb the relaxation stresses during the cooling of the glazed unit. Thus, unexpectedly, the result of this is that the addition of this OCA layer 20 in the stack of the laminated glazed unit 1 minimizes the visual defects of the glazed unit.

The OCA layer 20 may be a transparent adhesive material which has been deposited in liquid form on the first flexible substrate 21 thus serving as support, which has been encapsulated using the second flexible substrate 22 and which has been crosslinked, in order to form a sandwiched viscoelastic layer. Alternatively, the OCA layer 20 may be a transparent material in polymerized or prepolymerized film form. It may be a pressure-sensitive adhesive (PSA) or what is referred to as a post-adhesive polymer film which has been partially crosslinked before assembly, and which will be fully crosslinked after assembly. The PSA film is typically adhesively bonded to the flexible substrate 22 by contact and application of mechanical pressure. The post-adhesive film is typically brought into contact with the flexible substrate 22 before carrying out the crosslinking causing adhesion to the substrate. The crosslinking is generally carried out by photocrosslinking, especially using UV irradiation. Before carrying out the crosslinking, the assembled glazed unit is placed under vacuum for degassing, then placed in a pressurized autoclave with a positive pressure of 2 to 4 bar, for example, and optionally at a temperature greater than ambient temperature. The use of a post-adhesive film proves particularly advantageous for producing bent glazed units.

Advantageously, the hardness of the OCA layer 20 is between 10 and 50 Shore000, especially between 10 and 30 Shore000. The thickness of the OCA layer 20 is typically greater than 0.5 μm, preferably within a range of values from 0.5 mm to 2 mm.

By way of example, the OCA is based on viscoelastic silicone. This OCA made of viscoelastic silicone has a hardness between 10 and 30 Shore000. The OCA layer made of viscoelastic silicone has a thickness of 1 mm. The PSA film is preferably selected from polymers based on acrylate, on urethane acrylate, or made of fluorinated urethane acrylate or silicone. The post-adhesive film is preferably a photocrosslinked post-adhesive film based on acrylate.

In the example of functional film 2 from FIGS. 4 and 5, the second flexible substrate 22 is a guest-host liquid crystal cell, for example a commercially available one, the external face of the guest-host cell forming the external face of the flexible functional film 2. For FIGS. 6 and 7, the third substrate 23 does not necessarily have a technical function but makes it possible to sandwich a guest-host liquid crystal cell 22 between two OCA layers 20; this symmetrical stack with two OCA layers on either side of the guest-host liquid crystal cell makes it possible, depending on the uses, to even better reduce the risk of optical defects, especially in reflection.

For FIGS. 4 to 7, the guest-host liquid crystal cell 22 has a mixture of a solution in liquid form, 22A, of liquid crystals and at least one dichroic dye, the mixture in liquid form being trapped between two encapsulation substrates made of flexible material, 22B and 22C, and a peripheral seal 22D. The two encapsulation substrates made of flexible material 22B and 22C are kept spaced apart by spacers (not shown) which are incorporated into the seal 22D, making it possible to delimit the leak tight cavity which accommodates the liquid solution 22A containing liquid crystals. The peripheral seal 22D is for example made of epoxy resin or silicone. The internal surface facing the cavity of each of the two encapsulation substrates 22B and 22C is covered with an electrode, for example made of ITO, itself covered with an alignment layer, the alignment layers being in contact with the liquid solution 22A. The liquid crystal cell 2 has a total thickness of between 250 and 350 μm. The liquid crystal functional film 2 has for example a thickness of approximately 1.4 mm (PET 0.4 mm/OCA 1 mm/guest-host cell 0.3 mm) or of the order of 2.5 mm (PET 0.4 mm/OCA 1 mm/guest-host cell 0.3 mm/OCA 1 mm/PET 0.4 mm). The laminated glazed unit 1 has its light transmission modified when an electrical voltage is applied to the electrodes of the liquid crystal cell 2.

The two encapsulation substrates 22B and 22C of the liquid crystal cell (of the functional film) 2 are flexible. They may be made of glass which is sufficiently thin to give the liquid crystal cell flexibility. The encapsulation substrates 22B and 22C made of glass have for example a thickness of less than 1000 μm, in particular of between 25 μm and 700 μm, preferably a thickness of less than 300 μm, or even less than 100 μm.

The laminated glazed unit 1 of FIG. 5 corresponds to the glazed unit of FIG. 1 for which the flexible functional film 2 corresponds to that of FIG. 4, in order to confer upon the glazed unit a light transmission which can be varied by virtue of the liquid crystal cell 22.

The laminated glazed unit 1 of FIG. 7 uses the functional film 2 of FIG. 6 for a light transmission function which can be varied by virtue of the liquid crystal cell 22 which is sandwiched between two OCA layers.

The functional film 2 of the invention with a viscoelastic OCA is advantageously used in a bent glazed unit. Laminated glazed units for bent roofs were manufactured and photographed at the edge thereof: the photo of FIG. 8 is a laminated glazed unit 1 of the invention in accordance with FIG. 5, comprising a liquid crystal cell 22 which has been laminated in the form of a flexible film of the invention comprising a viscoelastic silicone-based OCA layer and having a hardness between 10 and 30 Shore000, in comparison with the photo of FIG. 9 which is a laminated glazed unit using the same liquid crystal cell 22, but alone and directly laminated between two PVB interlayer films associated with the glass substrates. As can be seen in FIGS. 8 and 9, the laminated glazed unit of FIG. 9 shows creases at the edge, while the laminated glazed unit of the invention, which can be seen in FIG. 8, shows no defects (the photo of FIG. 8 shows the glazed unit with a moiré pattern behind the glazed unit in order to be able to more readily view visual defects, if they exist).

Moreover, other tests for manufacturing bent laminated glazed units were carried out with functional films containing guest-host cells for which the OCA layer is not viscoelastic, not making it possible to adapt the thickness within the functional film during the lamination of the glazed unit. In particular, two laminated glazed units were especially tested. These two glazed units were each laminated with functional films containing guest-host cells and comprising an OCA based on acrylate which is not viscoelastic after crosslinking and does not make it possible to adapt the thickness during the lamination process; the OCA based on acrylate has a hardness for the two glazed units, of 30 ShoreA and 55 ShoreA, respectively. Visual defects were present on these two tested laminated glazed units.

1: A laminated glazed unit, comprising
at least one first glass substrate and a second glass substrate,
at least one functional film arranged between the first and second glass substrates,
at least one first lamination interlayer film between the first glass substrate and the functional film, and
at least one second lamination interlayer film between the second glass substrate and the functional film,
wherein the functional film comprises at least one layer of a transparent adhesive material OCA, which is viscoelastic so as to be deformable in its thickness during a process for laminating the glazed unit.

2: The laminated glazed unit of claim 1, wherein the at least one OCA layer has a hardness of between 10 and 50 Shore000.

3: The laminated glazed unit of claim 1, wherein the at least one OCA layer has a thickness of greater than 0.5 mm.

4: The laminated glazed unit according to claim 1, wherein
the functional film comprises a first flexible transparent substrate, a first OCA layer, and a second flexible transparent substrate, and
the first flexible transparent substrate and/or the second flexible transparent substrate have a technical function.

5: The laminated glazed unit according to claim 1, wherein the functional film comprises a first flexible transparent substrate, a first OCA layer, a second flexible transparent substrate having a technical function, a second OCA layer, and a third flexible transparent substrate.

6: The laminated glazed unit according to claim 4, wherein the second flexible transparent substrate having a technical function is a liquid crystal cell.

7: The laminated glazed unit according to claim 6, wherein the liquid crystal cell is a “guest-host” cell containing a mixture of a liquid solution and liquid crystals.

8: The laminated glazed unit according to claim 6, wherein the liquid crystal cell is a polymer-dispersed liquid crystal (PDLC) system or a cholesteric liquid crystal (CLC) system or a polymer network liquid crystal (PNLC) system.

9: The laminated glazed unit according to claim 4, wherein the flexible transparent substrate having a technical function is an infrared-reflecting film.

10: The laminated glazed unit according to claim 1, wherein the OCA is a transparent adhesive material deposited in liquid form and crosslinked.

11: The laminated glazed unit according to claim 1, wherein the OCA is a transparent material in the form of a polymerized film, preferably a pressure sensitive film.

12: The laminated glazed unit according to claim 1, wherein the OCA is a transparent adhesive material in the form of a crosslinked post-adhesive film.

13: The laminated glazed unit according to claim 1, wherein the OCA is selected from the group consisting of an acrylic-based OCA, a polyvinyl acetate-based OCA, a polyurethane-based OCA, a silicon-based OCA, and an epoxy-based OCA.

14: The laminated glazed unit according to claim 1, which is bent.
